(19) United States
(12) Patent Application Publication
(10) Pub. No.: US 2011/0057868 A1
(43) Pub. Date: Mar. 10, 2011

(54) LIQUID CRYSTAL DISPLAY CAPABLE OF SWITCHING COMMON VOLTAGE

(76) Inventors: Ping-Lin Chen, Hsin-Chu (TW); Hsiao-Chung Cheng, Hsin-Chu (TW)

(21) Appl. No.: 12/603,546

(22) Filed: Oct. 21, 2009

(30) Foreign Application Priority Data
Sep. 10, 2009 (TW) 098130525

(51) Int. Cl. G09G 3/36

(52) U.S. Cl. 345/92; 345/87

(57) ABSTRACT

A liquid crystal display capable of switching the common voltage includes a display panel and a printed circuit board. The display panel includes a plurality of scan lines, a plurality of data lines, and a plurality of pixels. Each pixel includes a transistor, a storage capacitor, and a liquid crystal capacitor. The first ends of the storage capacitor and the liquid crystal capacitor are electrically connected to the transistor. The second end of the liquid crystal capacitor is electrically connected to a common voltage source. The printed circuit board includes a switcher for switching the second end of the storage capacitor electrically connecting to common voltage source, an analog voltage source, or a ground.

### BACKGROUND OF THE INVENTION

1. Field of the Invention

The present invention relates to a Liquid Crystal Display (LCD), and more particularly, to an LCD capable of switching the common voltage.

2. Description of the Prior Art

Since LCDs have the advantages of portability, low power consumption, and low radiation, LCDs have been widely used in various portable information products, such as notebooks, cell phones, personal digital assistants (PDA), flat panel televisions, etc. The LCD comprises a Thin Film Transistor (TFT) substrate, and a color filter substrate. A liquid crystal layer is sandwiched in between the TFT substrate and the color filter substrate. The rotation angle of the liquid crystal molecules in the liquid crystal layer can be controlled by means of controlling the drop voltage across the liquid crystal layer, so the transmittance of the liquid crystal layer changes as desired for displaying images.

Please refer to FIG. 1. FIG. 1 is a schematic diagram illustrating a convention TFT LCD panel (display panel) 10. The display panel 10 comprises a plurality of scan lines G1˜Gm, a plurality of data lines S1˜Sn, and a plurality of pixels. Each pixel comprises a transistor 12, a storage capacitor 14, and a liquid crystal capacitor 16. A parasitic capacitor 18 exists between the gate and the drain of the transistor 12. The pixel electrically connected to the scan line G1 and the data line 51 is illustrated as below for example. The gate of the transistor 12 is electrically connected to the scan line G1. The source of the transistor 12 is electrically connected to the data line S1. The drain of the transistor 12 is electrically connected to the pixel electrode; that is, the first end of the storage capacitor 14 and the first end of the liquid crystal capacitor 16. The liquid crystal capacitor is an equivalent capacitor formed by the liquid crystal layer sandwiched in between the two substrates (TFT substrate and the color filter substrate) of the display panel 10. The voltage inputted to the first end of the liquid crystal capacitor 16 is referred as a pixel voltage. The storage capacitor 14 is utilized for storing the pixel voltage until the next data signal is inputted. The voltage inputted to the second end of the liquid crystal capacitor 16 is referred as a common voltage VCOM. Generally speaking, the voltage level of the voltage Vcst on the second end of the storage capacitor 14 is equal to the common voltage VCOM, but sometimes the voltage Vcst of the storage capacitor 14 is adjusted for obtaining the desired display characteristics.

Please refer to FIG. 2. FIG. 2 is a waveform diagram illustrating the voltages of the display panel 10 in FIG. 1. When the scan-line voltage 22 goes up from Vgl to Vgh, the transistor 12 is turned on. The data-line voltage 24 charges the pixel electrode during the duty time Ton of the scan-line voltage 22. The pixel voltage 26 goes up from Vdl to Vdh. After the duty time Ton of the scan-line voltage 22, the scan-line voltage goes down to Vgl. Meanwhile, the transistor 12 is turned off so that the data line can not keep charging the pixel electrode. When the data-line voltage 24 goes down from Vdh to Vdl, the storage capacitor 14 keeps the pixel voltage at Vdh so that the pixel voltage 26 does not goes down to Vdl immediately. However, when the scan-line voltage 22 goes down from Vgh to Vgl, the pixel voltage 26 is reduced by a feed-through voltage ΔVp because of the coupling effect of the parasitic capacitor 18, generating the flicker phenomenon of the TFT LCD.

Please refer to FIG. 3. FIG. 3 is a schematic diagram illustrating a conventional method of setting the voltage Vcst of the storage capacitor 14. The effect of the feed-through voltage ΔVp is reduced in the display panel 10 by means of adjusting the voltage level of the common voltage. In addition, the voltage Vcst of the storage capacitor 14 is adjusted for obtaining the desired display characteristics. The common voltage VCOM and the voltage Vcst of the storage capacitor 14 are both provided by a printed circuit board (not shown in FIG. 1) electrically connected to the display panel 10. The voltage Vcst of the storage capacitor 14 is usually designed as a fixed voltage. If the voltage Vcst of the storage capacitor 14 is to be adjusted, the voltage Vcst has to be connected to the required voltage source through the resistor 31 of 0 ohm. The required voltage source includes the common voltage source VCOM, the ground GND, and the analog voltage source AVDD, wherein the printed circuit board divides the analog voltage AVDD for generating the gamma voltage. However, in this way, if the voltage Vcst of the storage capacitor is to be adjusted again, the resistor 31 of 0 ohm has to be removed by the welding torch at first, and then welded to the required voltage source again, wasting a lot of time and may causing a short-circuited problem or an open-circuited problem.

### SUMMARY OF THE INVENTION

It is therefore a primary objective of the present invention to provide a liquid crystal display capable of switching a common voltage.

The present invention provides a Liquid Crystal Display (LCD). The LCD comprises a display panel, and a printed circuit board. The display panel comprises a plurality of scan lines, a plurality of data lines, and a plurality of pixels. Each pixel comprises a transistor, a storage capacitor, and a liquid crystal capacitor. The transistor has a control end electrically connected to a scan line, a first end electrically connected to a data line, and a second end. The storage capacitor has a first end electrically connected to the second end of the transistor, and a second end. The liquid crystal capacitor has a first end electrically connected to the second end of the transistor, and a second end electrically connected to a first voltage source. The printed circuit board is electrically connected to the display panel. The printed circuit board comprises a switcher. The switcher is utilized for switching the second end of the storage capacitor electrically connecting to the first voltage source or a second voltage source.

The present invention further provides an LCD. The LCD comprises a Thin Film Transistor (TFT) substrate, a color filter substrate, a printed circuit board, and a switcher. The color filter substrate is utilized for sandwiching a liquid crystal layer with the TFT substrate. The printed circuit board is utilized for providing a first common voltage to the color filter substrate and providing a second common voltage to the TFT substrate. The switcher is disposed on the printed circuit board. The switcher is utilized for switching a voltage level of the second common voltage.

The present invention further provides a printed circuit board. The printed circuit board is utilized for providing a common voltage of an LCD. The printed circuit board comprises a common voltage source, an analog voltage source, a ground, and a switcher. A voltage level of the analog voltage source is higher than a voltage level of the common voltage source. A voltage level of the ground is lower than the voltage level of the common voltage source. The switcher comprises three input ends, and an output end. The three input ends of the switcher are respectively electrically connected to the common voltage source, the analog voltage source, and the ground. The output end of the switcher is utilized for outputting a voltage of the common voltage source, a voltage of the analog voltage source, or a voltage of the ground to the LCD.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a convention TFT LCD panel (display panel).

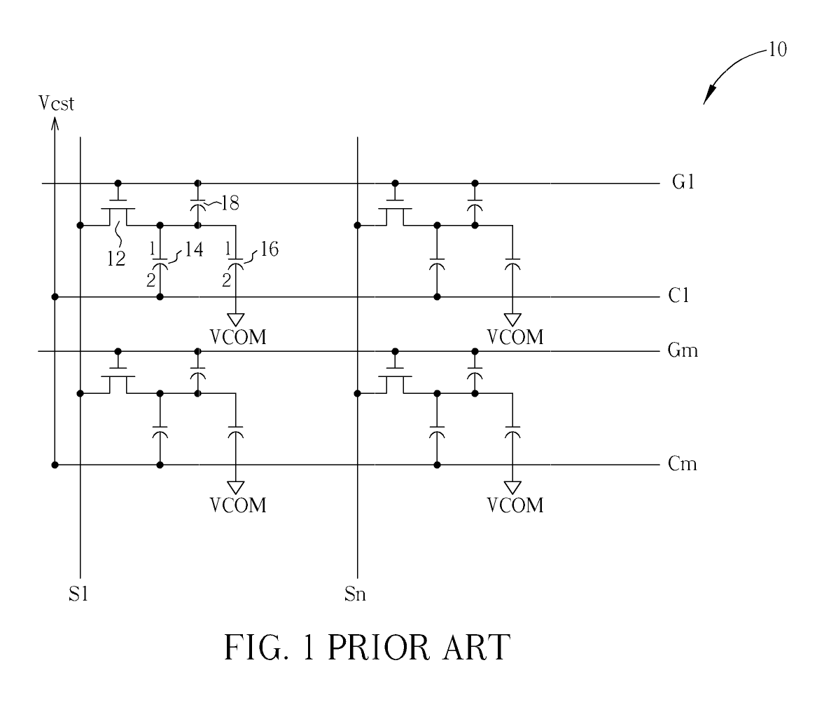

FIG. 2 is a waveform diagram illustrating the voltages of the display panel in FIG. 1.

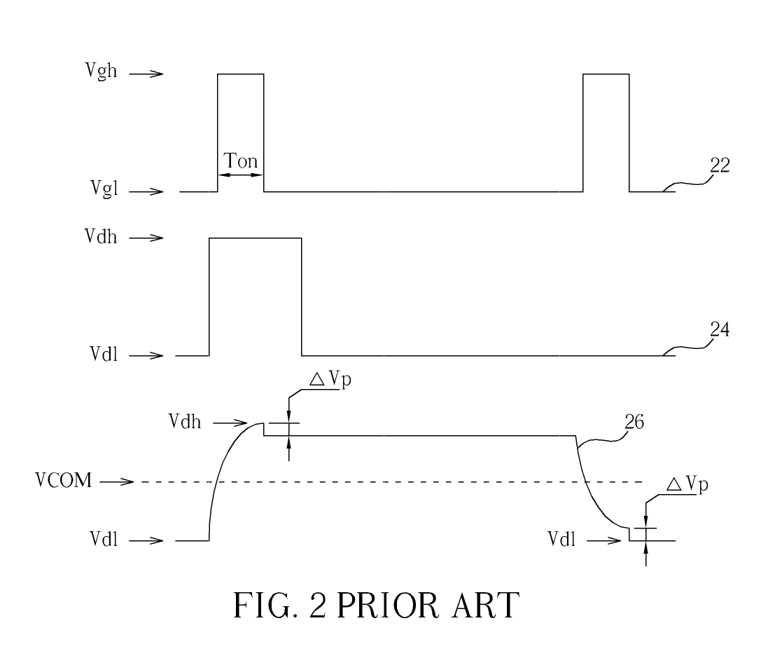

FIG. 3 is a schematic diagram illustrating a conventional method of setting the voltage of the storage capacitor.

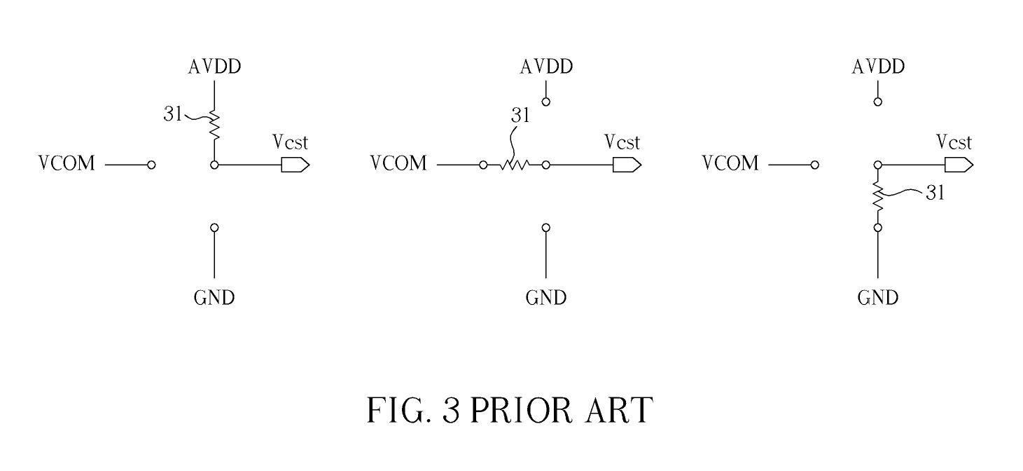

FIG. 4 is a schematic diagram illustrating a display of the present invention.

FIG. 5 is a schematic diagram illustrating a switcher according to a first embodiment of the present invention.

FIG. 6 is a schematic diagram illustrated a switcher according to a second embodiment of the present invention.

FIG. 7 is a schematic diagram illustrating adjusting the voltage of the storage capacitor by means of the switcher.

### DETAILED DESCRIPTION

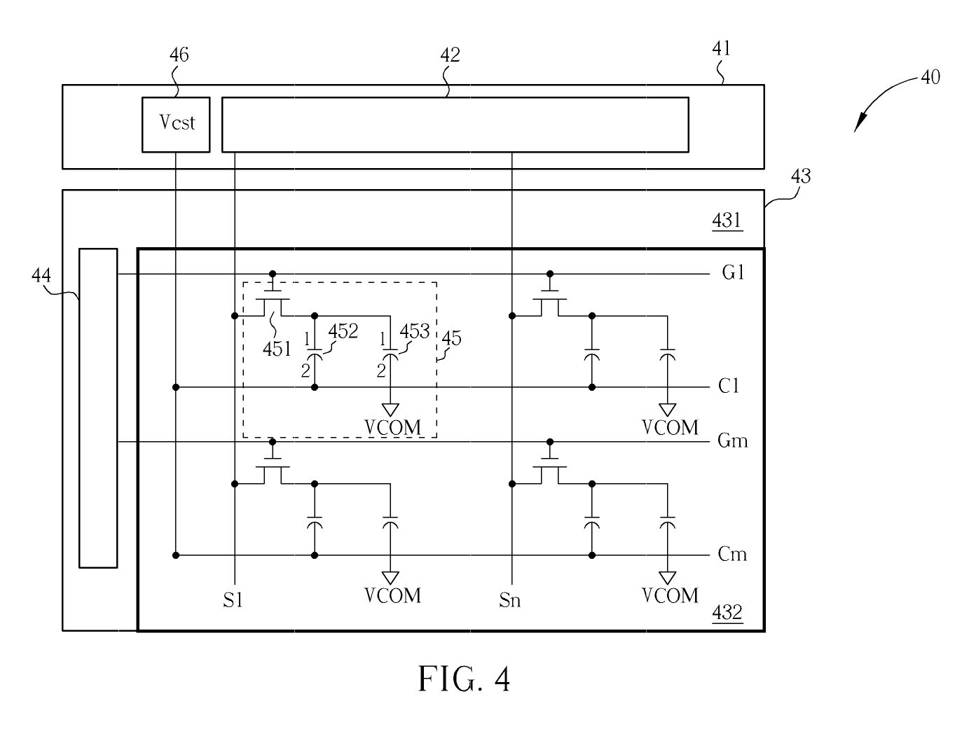

Please refer to FIG. 4. FIG. 4 is a schematic diagram illustrating a display of the present invention. In the present embodiment, the display is an LCD 40 for example. The LCD 40 comprises a printed circuit board 41, a source driver 42, a display panel 42, a gate driver 44, and a common voltage switcher 46. The source driver 42 and the common voltage switcher 46 are disposed on the printed circuit board 41. The gate driver 44 is disposed on the display panel 43. The display panel 43 comprises a TFT substrate 431, and a color filter substrate 432. The TFT substrate 431 comprises a plurality of scan lines G1˜Gm, a plurality of data lines S1˜Sn, and a plurality of pixels 45. Each pixel 45 comprises a transistor 451, a storage capacitor 452, and a liquid crystal capacitor 453. The liquid crystal capacitor 453 is an equivalent capacitor formed by a liquid crystal layer (not shown in FIG. 4) sandwiched in between the TFT substrate 431 and the color filter substrate 432. The first end of the liquid crystal capacitor 453 is electrically connected to the transistor 451 of the TFT substrate 431. The second end of the liquid crystal capacitor 453 is electrically connected to the color filter substrate 432. The first end of the storage capacitor 452 is electrically connected to the first end of the liquid crystal capacitor 453. The second end of the storage capacitor 452 is electrically connected to the common voltage switcher 46.

In the present embodiment, the second end of the liquid crystal capacitor 453 is electrically connected to the common voltage source VCOM. The second end of the storage capacitor 452 can be electrically connected to the common voltage source VCOM, the ground GND, or the analog voltage source AVDD, through the common voltage switcher 46. Therefore, the voltage Vcst of the storage capacitor 452 can be switched to be voltage VCOM, GND, or AVDD. Since the second end of the liquid crystal capacitor 453 is usually electrically connected to the common voltage source VCOM (generally speaking, the voltage level of the common voltage source VCOM is about 3.3V), a voltage source having a higher voltage level than the common voltage source VCOM and a voltage source having a lower voltage level than the common voltage source VCOM are selected to be the voltage sources for adjusting the voltage Vcst of the storage capacitor 451. The ground GND and the analog voltage source AVDD are the voltage sources used in general LCDs. The analog voltage source AVDD is utilized for generating the gamma voltage in the LCD. The voltage level of the analog voltage source AVDD is about 8.5V, and the voltage level of the ground GND is 0V.

In the present embodiment, the display is illustrated to be an LCD for example. However, the operational principle of the present invention can be applied for various displays. For example, the display can be an Electrophoresis Display (EPD), an Organic Light-Emitting Diodes (OLED) display, a flexible display, or an LED display according to the requirement.

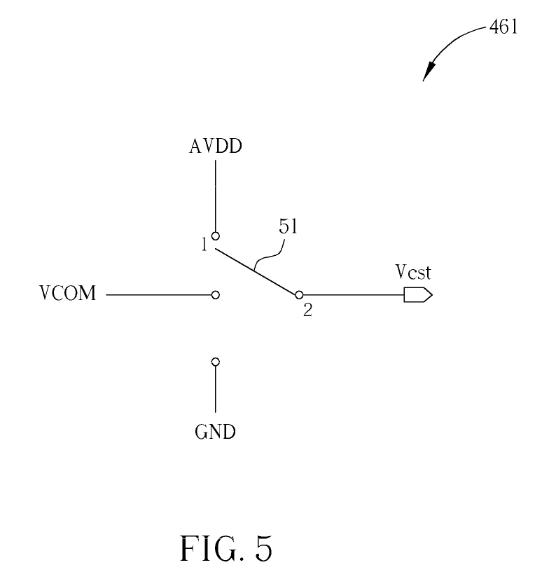

Please refer to FIG. 5. FIG. 5 is a schematic diagram illustrating a switcher 461 according to a first embodiment of the present invention. The switcher 461 comprises a switcher 51. The second end of the switcher 51 is electrically connected to the second end of the storage capacitor 452 (please refer to FIG. 4). The first end of the switcher 51 is selectively electrically connected to the common voltage source VCOM, the ground GND, or the analog voltage source AVDD according to the requirement. Comparing with the conventional method of using the resistor of 0 ohm for connecting to the required voltage source, the voltage Vcst of the storage capacitor 452 is easily adjusted to be connected to the required voltage source by means of the switcher 51. Hence, when some defects appear in the display panel, the voltage Vcst of the storage capacitor 452 can be switched to be equal to the voltages AVDD, VCOM, or GND according to the grades of the defects.

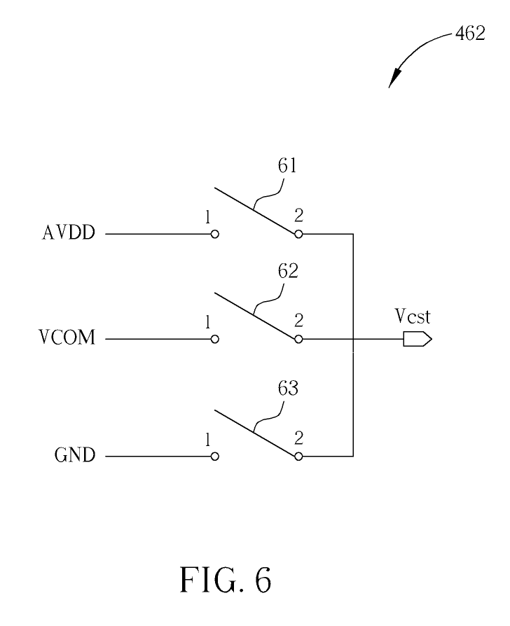

Please refer to FIG. 6. FIG. 6 is a schematic diagram illustrated a switcher 462 according to a second embodiment of the present invention. The switcher 462 comprises three switches 61, 62, and 63. The first ends of the switches 61, 62, and 63 are respectively electrically connected to the analog voltage source AVDD, the common voltage source VCOM, and the ground GND. The second ends of the switches 61, 62, and 63 are all electrically connected to the second end of the storage capacitor 452. The voltage Vcst of the storage capacitor 452 can be adjusted by mean of the switches 61, 62, and 63. For example, when the voltage Vcst of the storage capacitor 452 is to be adjusted to be the voltage AVDD, the switch 61 is turned on, and the switches 62 and 63 are turned off; when the voltage Vcst of the storage capacitor 452 is to be adjusted to be the voltage VCOM, the switch 62 is turned on, and the switches 61 and 63 are turned off; when the voltage Vcst of the storage capacitor 452 is to be adjusted to be the voltage GND, the switch 63 is turned on, and the switches 61 and 63 are turned off. As a result, when one of the switches 61, 62, and 63 is turned on, the other two switches are turned off.

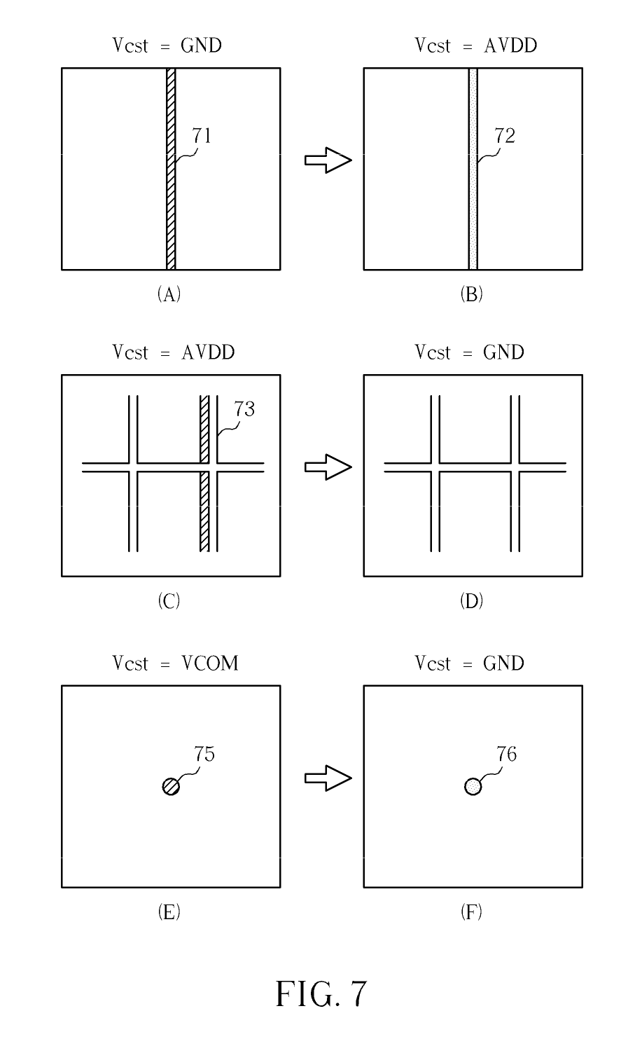

Please refer to FIG. 7. FIG. 7 is a schematic diagram illustrating adjusting the voltage Vcst of the storage capacitor by means of the switcher 46. In the fabrication of the LCD panel, if the TFT substrate and the color filter substrate are assembled incorrectly, the Photo Spacer (PS) can not move back to the original location when the LCD panel is flapped, generating the mura 71 (means the color is not uniform) as shown in the panel (A) of FIG. 7. The voltage Vcst of the storage capacitor of the panel (A) is equal to the voltage GND. If the voltage Vcst of the storage capacitor of the panel (A) is adjusted to be equal to the voltage AVDD, since the liquid crystal molecules change the rotation angle because of the lateral electrical field, the mura 71 of the panel (A) can be reduced as shown in the part 72 of the panel (B), so the image quality of the LCD is improved. The similar situations are shown in the panel (C) and the panel (D). In the panel (C), the voltage Vcst of the storage capacitor is equal to the voltage AVDD, and the phenomenon of the light leakage is generated in the edge between the pixel and the data line (shown as the part 73). If the voltage Vcst of the storage capacitor is adjusted to be equal to the voltage GND at the time, the liquid crystal molecules change the rotation angle because of the lateral electrical field generated by the voltage Vcst of the storage capacitor and the data line. In this way, the phenomenon of the light leakage is improved as shown in the panel (D). In addition, in the panel (E), the voltage Vcst of the storage capacitor is equal to the voltage VCOM. The panel (E) is normally white when the voltage is not inputted. If the two ends of the storage capacitor of a pixel is shorten-circuited due to the contamination during the fabrication, there is no voltage drop across the two ends of the liquid crystal capacitor of the pixel so the pixel becomes a bright point 75. As shown in the panel (F), if the voltage Vcst of the storage capacitor is adjusted to be equal to the voltage GND, a voltage drop is generated between the two ends of the liquid crystal capacitor of the pixel so the pixel becomes a dark point 76. Comparing with the bright point 75, the dark point 76 is unapparent. Thus, in the example of the panels (E) and (F), the repair process for the bright points can be easily executed by means of adjusting the voltage Vcst of the storage capacitor. In the above-mentioned illustration, the different defects of the panel can be improved respectively by means of adjusting the voltage Vcst of the storage capacitor to be equal to the voltages AVDD, VCOM, or GND. However, it is most important that since the voltage Vcst of the storage capacitor can be immediately adjusted by means of the switcher of the present invention, the grades of the defects can be easily compared when the voltage Vcst of the storage capacitor is adjusted. In this way, the voltage Vcst of the storage capacitor can be immediately adjusted according to the grades of the defects.

In conclusion, the present invention provides a liquid crystal display capable of switching the common voltage. The liquid crystal display includes a display panel and a printed circuit board. The display panel includes a plurality of scan lines, a plurality of data lines, and a plurality of pixels. Each pixel includes a transistor, a storage capacitor, and a liquid crystal capacitor. The first ends of the storage capacitor and the liquid crystal capacitor are electrically connected to the transistor. The second end of the liquid crystal capacitor is electrically connected to a common voltage source. The printed circuit board includes a switcher for switching the second end of the storage capacitor electrically connecting to common voltage source, an analog voltage source, or a ground. In the liquid crystal display of the present invention, since, the voltage on the second end of the storage capacitor can be immediately adjusted by means of the switcher, the different defects can be easily improved, causing a great convenience.

Those skilled in the art will readily observe that numerous modifications and alterations of the device and method may be made while retaining the teachings of the invention.

What is claimed is:

1. A Liquid Crystal Display (LCD), comprising:
a display panel, comprising a plurality of scan lines, a plurality of data lines, and a plurality of pixels, each pixel comprising:
a transistor, having a control end electrically connected to a scan line, a first end electrically connected to a data line, and a second end;
a storage capacitor, having a first end electrically connected to the second end of the transistor, and a second end; and
a liquid crystal capacitor, having a first end electrically connected to the second end of the transistor, and a second end electrically connected to a first voltage source; and
a printed circuit board, electrically connected to the display panel, the printed circuit board comprising:
a switcher, for switching the second end of the storage capacitor electrically connecting to the first voltage source or a second voltage source.

2. The LCD of claim 1, wherein a voltage level of the second voltage source is lower than a voltage level of the first voltage source.

3. The LCD of claim 2, wherein the first voltage source is a common voltage source, and the second voltage source is a ground.

4. The LCD of claim 1, wherein a voltage level of the second voltage source is higher than a voltage level of the first voltage source.

5. The LCD of claim 4, wherein the first voltage source is a common voltage source, and the second voltage source is an analog voltage source.

6. The LCD of claim 1, wherein the switcher is utilized for switching the second end of the storage capacitor electrically connecting to the first voltage source, the second voltage source, and a third voltage source.

7. The LCD of claim 6, wherein a voltage level of the second voltage source is lower than a voltage level of the first voltage source, and a voltage level of the third voltage source is higher than the voltage level of the first voltage source.

8. The LCD of claim 7, wherein the first voltage source is a common voltage source, the second voltage source is a ground end, and the third voltage source is an analog voltage source.

9. A Liquid Crystal Display (LCD), comprising:
a Thin Film Transistor (TFT) substrate;
a color filter substrate, for sandwiching a liquid crystal layer with the TFT substrate;
a printed circuit board, for providing a first common voltage to the color filter substrate and providing a second common voltage to the TFT substrate; and
a switcher, disposed on the printed circuit board, for switching a voltage level of the second common voltage.

10. The LCD of claim 9, wherein the TFT substrate comprises a plurality of scan lines, a plurality of data lines, and a plurality of pixels, each pixel comprising:
a transistor, having a control end electrically connected to a scan line, a first end electrically connected to a data line, and a second end;
a storage capacitor, having a first end electrically connected to the second end of the transistor, and a second end for receiving the second common voltage.

11. The LCD of claim 9, wherein the second common voltage comprises a first voltage level and a second voltage level.

12. The LCD of claim 11, wherein the first voltage level is equal to a voltage level of the first common voltage, and the second voltage level is lower than the first voltage level.

13. The LCD of claim 11, wherein the first voltage level is equal to a voltage level of the first common voltage, and the second voltage level is higher than the first voltage level.

14. The LCD of claim 9, wherein the second common voltage comprises a first voltage level, a second voltage level, and a third voltage level.

15. The LCD of claim 14, wherein the first voltage level is equal to a voltage level of the first common voltage, the second voltage level is lower than the first voltage level, and the third voltage level is higher than the first voltage level.

16. A printed circuit board, for providing a common voltage of a Liquid Crystal Display (LCD), the printed circuit board comprising:
a common voltage source;
an analog voltage source, wherein a voltage level of the analog voltage source is higher than a voltage level of the common voltage source;
a ground, wherein a voltage level of the ground is lower than the voltage level of the common voltage source; and
a switcher, comprising three input ends respectively electrically connected to the common voltage source, the analog voltage source, and the ground, and an output end for outputting a voltage of the common voltage source, a voltage of the analog voltage source, or a voltage of the ground to the LCD.

17. The printed circuit board of claim 16, wherein the LCD comprises:
a Thin Film Transistor (TFT) substrate, electrically connected to the output end of the switcher; and
a color filter substrate, electrically connected to the common voltage source.

18. The printed circuit board of claim 17, wherein the TFT substrate comprises a plurality of scan lines, a plurality of data lines, and a plurality of pixels, each pixel comprising:
a transistor, having a control end electrically connected to a scan line, a first end electrically connected to a data line, and a second end; and
a storage capacitor, having a first end electrically connected to the second end of the transistor, and a second end electrically connected to the output end of the switcher.
